(19) United States
(12) Patent Application Publication
(10) Pub. No.: US 2011/0010113 A1
(43) Pub. Date: Jan. 13, 2011

(54) Pressure gauge calibration method and pressure gauge

(76) Inventor: Ching-Pin Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,401

(22) Filed: Jul. 10, 2009

(51) Int. Cl. G01L 27/00

(52) U.S. Cl. 702/50

(57) ABSTRACT

This invention relates to a pressure gauge calibration method and a pressure gauge in which a container filled with mixture of saturated vapor and liquid, a contrast table of standard temperature versus saturated vapor properties, and a pressure gauge for measuring temperature and pressure is utilized. In implementation, the temperature sensing unit of the pressure gauge measures the temperature of the saturated vapor and the pressure sensing unit of the pressure gauge measures the pressure of the saturated vapor, then the values obtained are in contrast with the standard temperature versus saturated vapor properties. If error is happened, pressure gauge is adjusted to correct value which is interlinked to the processor to conduct the calibration of reference. In this manner, the pressure gauge calibration can be finished easily and quickly at the installation site.

### BACKGROUND OF THE INVENTION

1. Field of the Invention

This invention relates to a pressure gauge calibration method and a pressure gauge, particularly to a pressure gauge calibration method and a pressure gauge in which the calibration of pressure gauge can be finished easily and quickly at the construction site.

2. Brief Description of Prior Art

Refrigerant of air-conditioner, refrigerator, freezer needs to be checked periodically so that refrigerant can be charged in case of insufficiency. Thus, normal operating function of air-conditioner, refrigerator, and freezer can be maintained.

When checking and charging refrigerant, measuring instruments like pressure gauge have to be used therewith so that the current refrigerant amount of the air-conditioner, refrigerator, and freezer can be concretely ascertained by the constructor. What is more, the refrigerant quantity can be caught on time from the pressure gauge so as to achieve the effect of correct charging.

Therefore, the accuracy of pressure gauge itself is very important for constructor to catch the refrigerant quantity so that the charging amount of refrigerant can be precisely controlled in the charging operation. Thus, the danger resulted from sustained charging of refrigerant in case of over-saturation state can be prevented.

Usually, pressure gauge has to pass through examination and calibration procedures before leaving the factory. Current calibration method of pressure gauge, referring to FIG. 6, essentially adopts a standard pressure source capable of generating a standard pressure to connect with the pressure gauge and to output a standard pressure to the pressure gauge. At this moment, if the value measured by the pressure gauge is deviated from the output standard pressure, the pressure gauge can be adjusted to the same value as the output standard pressure so as to finish the calibration of the pressure gauge.

Another calibration method of pressure gauge, referring to FIG. 7, is to output a pressure from a pressure source, and then the pressure output from the pressure source is precisely measured by a transfer standard so as to obtain a standard pressure value. In turn, the pressure gauge to be calibrated is connected with the pressure source and the pressure value obtained by the measurement of the pressure gauge to be calibrated is in contrast with the standard pressure measured by the transfer standard. If error is happened, the pressure gauge is calibrated to the pressure value measured by the transfer value so as to complete the calibration process of the pressure gauge.

Therefore, there is no need to doubt about the accuracy of pressure gauge at the early stage after leaving factory, user can believe the pressure value measured by the pressure gauge for construction. However, the pressure value measured by the pressure gauge is possible to generate error after a considerable time period of usage, and thus a re-calibration is required so as to avoid the happening of construction error or unnecessary hazard due to the error of pressure value measured at the instant of construction. However, the standard source for generating standard pressure or the transfer standard capable of measuring pressure value has very high precision itself, expensive and bulk volume such that neither of them is suitable to be used in conducting the calibration at construction site.

Therefore, how to ensure the preciseness of all the pressure value measured by pressure gauge in the operation of refrigerant charging each time so as to guarantee the quality and safety of installation has been a critical issue of concerned department of government, users of pressure gauge and makers of pressure gauge.

In view of the above facts, inventor of the present invention proposes a novel pressure gauge convenient for conducting pressure gauge calibration at installation site, and its implementation method.

### SUMMARY OF THE INVENTION

This invention relates to a pressure gauge calibration method and a pressure gauge the object of which is to provide a pressure gauge capable of finishing pressure gauge calibration easily and quickly at installation site and its calibration method.

As a result, inventor of this invention proposes a pressure gauge calibration method, in which a container filled with mixture of saturated vapor and liquid, a contrast table of standard temperature versus saturated vapor properties, and a pressure gauge for measuring temperature and pressure are provided. In implementation, the temperature sensing unit of the pressure gauge measures the temperature of the saturated vapor and the pressure sensing unit of the pressure gauge measures the pressure of the saturated vapor, then the values obtained are in contrast with the standard temperature versus saturated vapor properties listed on the contrast table. If error is happened, the pressure gauge is adjusted to correct value which is then interlinked to the processor to conduct the calibration of reference. In this manner, the pressure gauge calibration can be finished easily and quickly at the installation site.

Furthermore, for the sake of facilitating pressure gauge calibration in more rapid and convenient manner, inventor of this invention further proposes a pressure gauge in which the data of temperature in contrast with the saturated vapor are stored in the memory, and the memory is electrically connected with a processor. In this manner, the processor conducts the integrated computation with respect to the measured temperature and the pressure values of saturated vapor and saturated liquid in coordination with the corresponding data of temperatures versus saturated vapor and saturated liquid properties stored in the memory so as to achieve the effect of automatic calibration for pressure gauge.

### BRIEF DESCRIPTION OF THE DRAWINGS

FIG. 1 is a view showing the structure of the present invention.

FIG. 2 is a perspective view showing the using state of the present invention.

FIG. 3 is a sectional view showing the using state of the present invention.

FIG. 4 is a contrast table of temperature versus saturated vapor and saturated liquid of the present invention.

FIG. 5 is a view showing the structure of another embodiment of the present invention.

FIG. 6 is a structural view showing the first implementation of pressure calibration of prior art.

FIG. 7 is a structural view showing the second implementation of pressure calibration of prior art.

### DETAILED DESCRIPTION OF PREFERRED EMBODIMENTS

The technical content, objects and effectiveness of the present invention will become more apparent by the detailed description of preferred embodiments of the present invention in conjunction with the accompanying drawings.

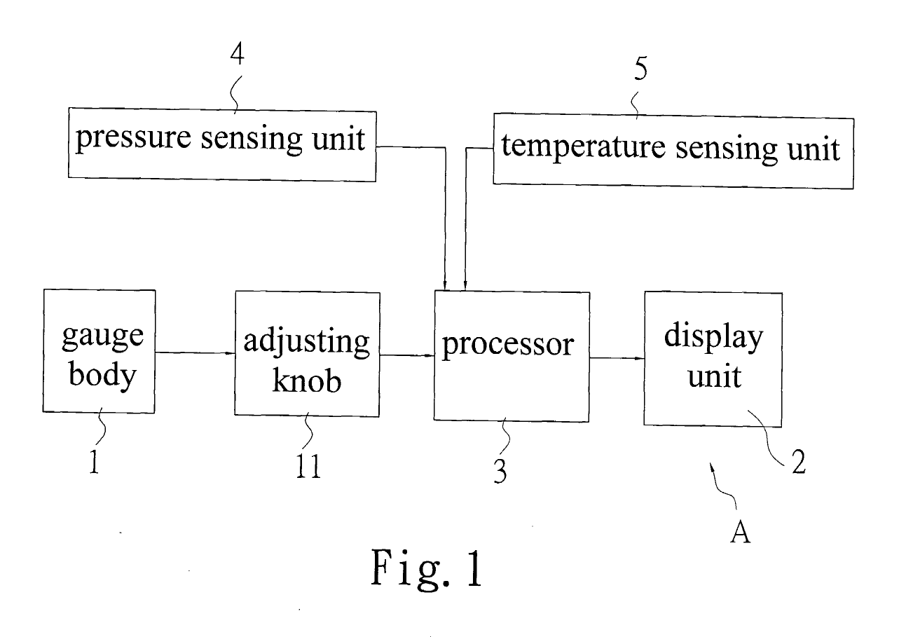

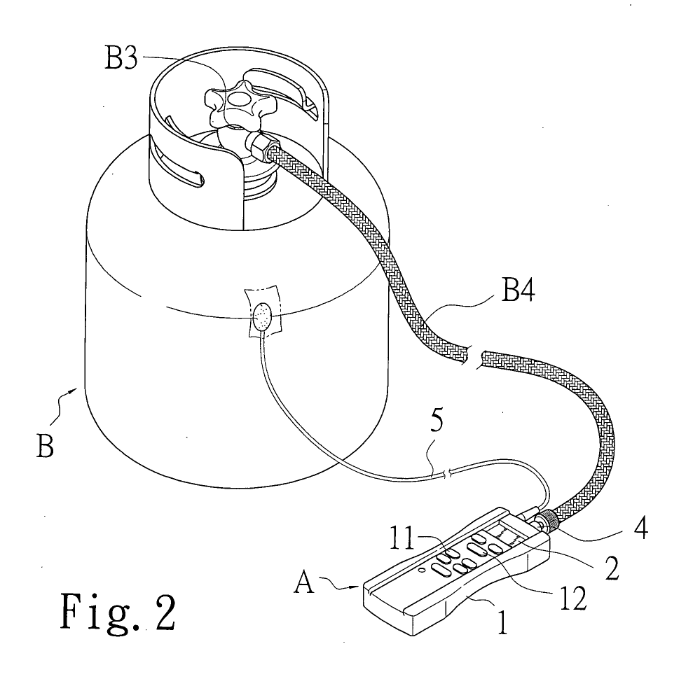

Firstly referring to FIGS. 1 and 2 showing the pressure gauge calibration method and the pressure gauge of the present invention, the pressure gauge (A) comprises a gauge body (1), a display unit (2), a processor (3), a pressure sensing unit (4) and a temperature sensing unit (5), in which:

the gauge body (1) is essentially provided with an adjusting knob (11) which is electrically connected to the processor (3);

the display unit (2) is assembled on the gauge body (1) and is electrically connected to the processor (3);

the processor (3) is assembled in the gauge body (1);

the pressure sensing unit (4) is assembled on the end portion of the gauge body (1) and is electrically connected to the processor (3);

the temperature sensing unit (5) is assembled with the gauge body (1) and is electrically connected to the processor (3).

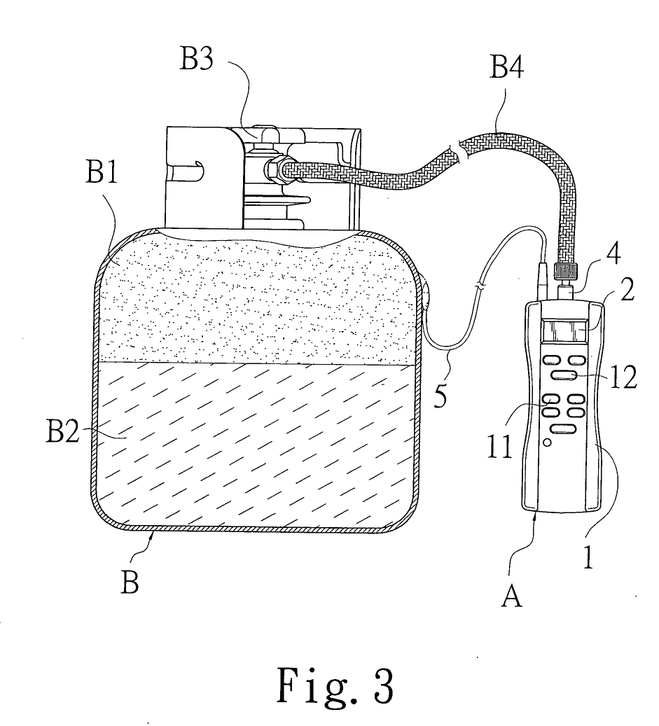

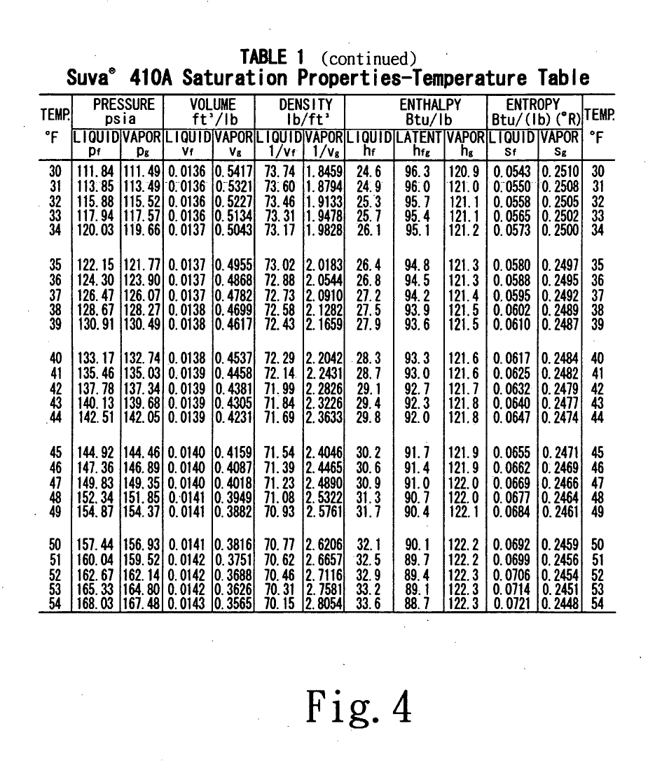

With this structure, when the pressure gauge is used and implemented in installation site, also referring to FIG. 3, a container (B) [it can be a refrigerant barrel or gas barrel] filled with saturated vapor (B1) and saturated liquid (B2) is prepared, then the temperature sensing unit (5) of the pressure gauge (A) is adhered on the upper portion of the cylinder wall of the container (B) so as to measure the temperature of the saturated vapor (B1) on the upper part of the container (B). Furthermore, a communication tube (B4) is provided to communicate with the valve-opening of a valve (B3) provided on the top of the container (B), and the other end of the communication tube (B4) is connected with the pressure sensing unit (4) of the pressure gauge (A).

In turn, the power of the pressure gauge (A) is started so that the temperature sensing unit (5) of the pressure gauge (A) transmits the measured temperature value of saturated vapor (B1) to the processor (3) to display it on the display unit (2). In turn, the valve (B3) of the container (B) is opened so that the saturated vapor (B1) is delivered through the communication tube (B4) to the pressure sensing unit (4). At the same time, the measured pressure value of the saturated vapor (B1) is transmitted by the pressure sensing unit (4) to the processor (3) to conduct signal processing, and then the data is displayed on the display unit (2).

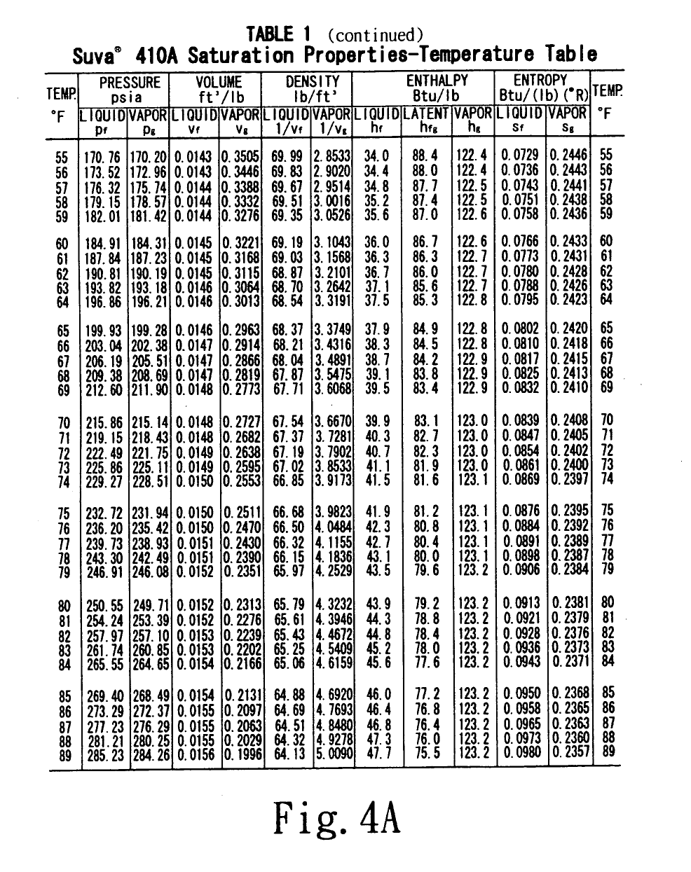

Subsequently, constructor conducts the contrast of the measured temperature and pressure values of the saturated vapor (B1) with the temperature versus saturated vapor and saturated liquid properties listed on the contrast table, as shown in FIG. 4, so as to know the exact pressure value the saturated vapor (B1) should have in contrast with the temperature. For example, when the temperature of the saturated vapor (B1) measured by the pressure gauge (A) is 77° F. and the pressure value of the saturated vapor (B1) is 238.90 psia, then in contrast to the contrast table of temperature versus the saturated vapor and the saturated liquid as shown in FIG. 4, the pressure value of the saturated vapor at 77° F. should be 238.93 psia. So, constructor now understands that the pressure gauge (A) has error and needs to be calibrated. In turn, constructor presses the adjusting knob (11) so as to adjust the pressure value from 238.90 psia to 238.93 psia, simultaneously this value is interlinked with the processor (3) to conduct the calibration action of reference.

Furthermore, constructor reverses the container (B) such that the saturated liquid (B2) in the container (B) flows toward the valve (B3) disposed on the top of the container (B). At this moment, the temperature value measured by the temperature sensing unit (5) adhered on the upper portion of the cylinder wall of the container (B) is the temperature of saturated liquid. In turn, the valve (B3) of the container (B) is opened so that the pressure sensing unit (4) detects the pressure of the saturated liquid (B2). Then, the temperature value and the pressure value of the saturated liquid (B2) measured by the temperature sensing unit (5) and the pressure sensing unit (4) are transmitted to the processor (3) and displayed on the display unit (2). At this instant, if the temperature value and the pressure value of the saturated liquid (B2) displayed on the display unit (2) are 77° F. are 239.73 psia, this proves that the pressure gauge (A) is precisely calibrated. By the double-check action conducted in this manner, the accuracy of the pressure gauge (A) can be assured so that installer can feel at ease to use the pressure gauge (A) to conduct refrigerant charging.

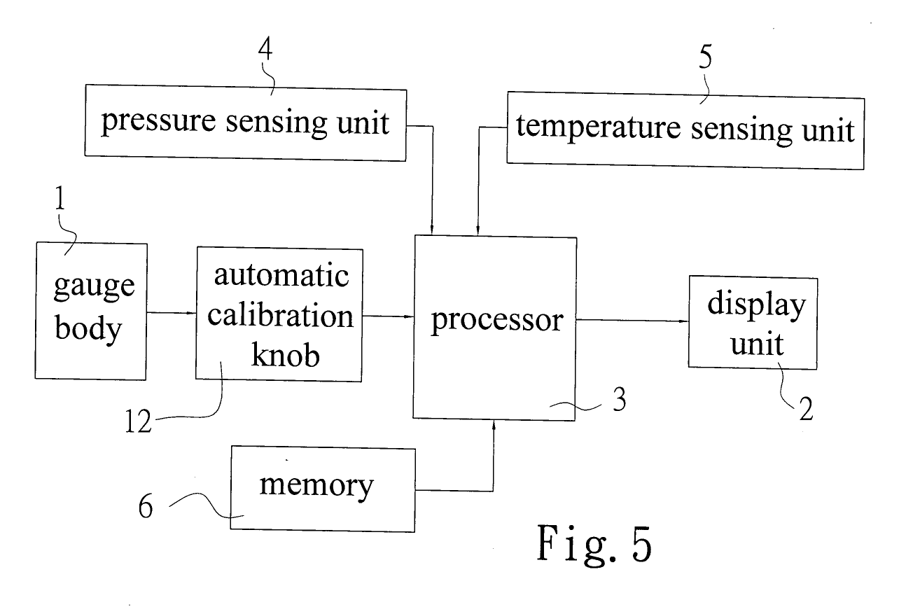

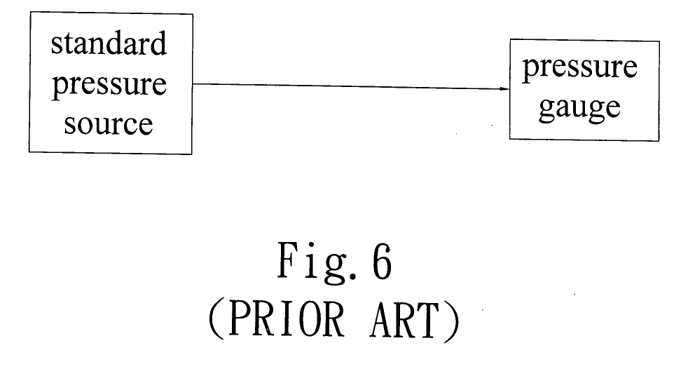

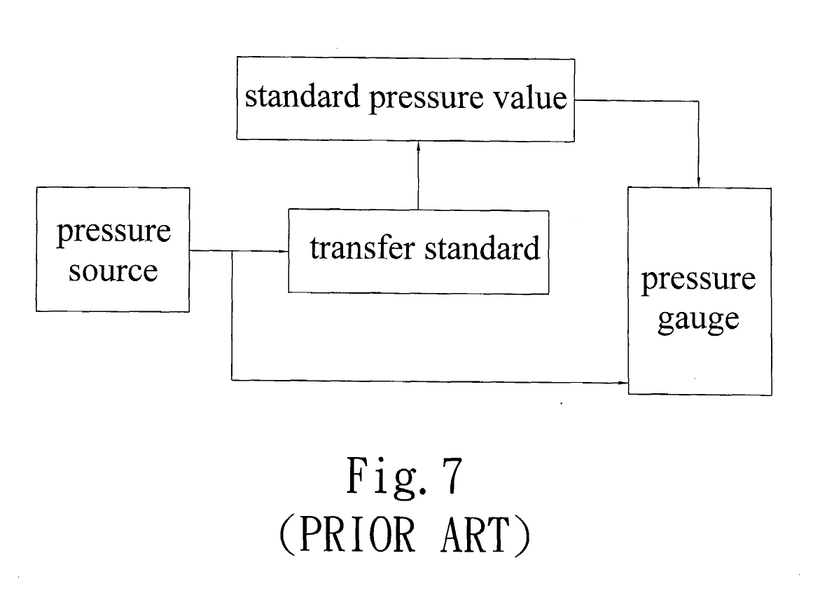

Referring together to FIG. 5 showing another embodiment of the present invention, the pressure gauge (A) is further provided with a memory (6), stored with contrasted data of temperature versus saturated vapor and saturated liquid, in the gauge body (1) and with an automatic calibration knob (12) assembled on the gauge body (1). The memory (6) and the automatic calibration knob (12) are electrically connected to the processor (3). With this structure, when the pressure sensing unit (4) and the temperature sensing unit (5) are assembled in the corresponding temperature and pressure sensing region, the corresponding temperature value and the pressure value of the saturated vapor (B1) or the temperature value and the pressure value of the saturated liquid (B2) can be obtained from the pressure sensing unit (4) and the temperature sensing unit (5). In turn, constructor presses the automatic calibration knob (12) so as to start the processor (3) for computation treatment. The processor (3) conducts the integrated computation with respect to the measured temperature value and the pressure values of saturated vapor (B1) or with respect to the temperature value and the pressure value of the saturated liquid (B2), in coordination with the corresponding data of temperatures versus saturated vapor and saturated liquid stored in the memory (6) as the standard so as to achieve the automatic calibration effect for pressure gauge (A).

The pressure gauge calibration method and the pressure gauge of the present invention is not merely limited to the pressure gauge calibration in the measuring of refrigerant or gas, it can be also implemented in the pressure measurement of whatever mixture of gas and liquid to calibrate pressure gauge on the spot at construction site so as to ensure the accuracy of pressure measurement in construction.

Based on the description of the elements constitution and the implementation of foregoing, the pressure gauge calibration method and the pressure gauge of the present invention has the following advantages when comparing with the conventional structure.

1. By utilizing a container filled with saturated vapor and liquid refrigerant, a contrast table of temperature versus saturated vapor and saturated liquid, and a pressure gauge capable of measuring temperature and pressure, this invention can finishes the pressure gauge calibration easily and quickly at construction site so as to ensure the quality and safety at construction site.
2. The pressure gauge of the present invention is further provided with a memory stored with contrast data of temperature versus saturated vapor and saturated liquid. The processor conducts the integrated computation with respect to the measured temperature value and the pressure values of saturated vapor or with respect to the temperature value and the pressure value of the saturated liquid, in coordination with the corresponding data of temperatures versus saturated vapor and saturated liquid stored in the memory so as to achieve the automatic calibration effect in more convenient manner for pressure gauge.

What is claimed is:

1. A pressure gauge calibration method, comprising following steps:
a. providing a container filled with mixture of saturated vapor and liquid and provided with valve;
b. providing a contrast table of standard temperature versus saturated vapor;
c. providing a pressure gauge, which includes:
a gauge body essentially provided with an adjusting knob which is electrically connected to a processor;
a display unit assembled on said gauge body and electrically connected to said processor;
a processor assembled in said gauge body;
a pressure sensing unit assembled on one end of said gauge body and electrically connected to said processor;
a temperature sensing unit assembled with said gauge body and electrically connected to said processor;
d. said temperature sensing unit of said pressure gauge being adhered to the outer wall of the container filled with saturated vapor and saturated liquid, and said pressure sensing unit being connected with the valve-opening of a valve by a communication tube, and the position adhered with said temperature sensing unit being directed to the place of saturated vapor so as to measure the temperature value of saturated vapor, while the pressure sensing unit measuring the pressure value of saturated vapor;
e. starting said pressure gauge so that said temperature sensing unit and said pressure sensing unit respectively measure the temperature value and the pressure value of saturated vapor, and the temperature value and the pressure value of saturated vapor being transmitted to said processor and being displayed on said display unit;
f. contrasting the temperature value and the pressure value of saturated vapor measured by said pressure gauge with said contrast table of temperature versus saturated vapor properties;
g. pressing said adjusting knob of said pressure gauge if an error is happened between the temperature value and the pressure value of saturated vapor measured by said pressure gauge with the standard temperature value and pressure value in said contrast table of temperature versus saturated vapor properties so that the temperature value and the pressure value of saturated vapor measured by said pressure gauge is adjusted to the standard temperature value and pressure value of saturated vapor which are then interlinked to said processor to conduct the pressure gauge calibration.

2. A pressure gauge calibration method as claimed in claim 1, wherein said contrast table further includes contrast data of temperature versus saturated liquid properties.

3. A pressure gauge calibration method, comprising following steps:
a. providing a container filled with mixture of saturated vapor and liquid and provided with valve;
b. providing a pressure gauge, which includes:
a gauge body essentially provided with an automatic calibrating knob which is electrically connected to a processor;
a display unit assembled on said gauge body and electrically connected to said processor;
a processor assembled in said gauge body;
a memory, assembled within said gauge body and electrically connected to said processor, in which contrast data of standard temperature versus saturated vapor is stored therein;
a pressure sensing unit assembled on one end of said gauge body and electrically connected to said processor;
a temperature sensing unit assembled with said pressure gauge and electrically connected to said processor;
c. said temperature sensing unit of said pressure gauge being adhered to the outer wall of said container filled with saturated vapor and liquid, and the pressure sensing unit being connected with the valve-opening of a valve by a communication tube, and the position adhered with said temperature sensing unit being directed to the place of saturated vapor so as to measure the temperature value of saturated vapor, while the pressure sensing unit measuring the pressure value of saturated vapor;
d. starting said pressure gauge so that said temperature sensing unit and said pressure sensing unit respectively measure the temperature value and the pressure value of saturated vapor, and the temperature value and the pressure value of saturated vapor being transmitted to said process and being displayed on said display unit;
e. pressing said automatic calibrating knob for starting the processor to conduct computation, said processor conducting integrated computation with respect to the temperature value of saturated vapor and the pressure value of saturated vapor measured by said pressure gauge in coordination with the contrast data of standard temperature versus saturated vapor properties as reference so as to calibrate the pressure gauge automatically.

4. A pressure gauge calibration method as claimed in claim 3, wherein said memory of said pressure gauge is further stored with contrast data of temperature versus saturated liquid properties.

5. A pressure gauge, comprising:
a gauge body essentially provided with an automatic calibrating knob which is electrically connected to a processor;
a display unit assembled on said gauge body and electrically connected to said processor;
a processor assembled in said gauge body;
a memory, assembled within said gauge body and electrically connected to said processor, in which contrast data of standard temperature versus saturated vapor is stored therein;
a pressure sensing unit assembled on one end of said gauge body and electrically connected to said processor;
a temperature sensing unit assembled with said pressure gauge and electrically connected to said processor.

6. A pressure gauge as claimed in claim 5, wherein said memory of said pressure gauge is further stored with contrast data of temperature versus saturated liquid properties.

7. A pressure gauge as claimed in claim 5, wherein said gauge body is further provided with an adjusting knob which is electrically connected to said processor.
